(19) United States
(12) Patent Application Publication
(10) Pub. No.: US 2014/0330836 A1
(43) Pub. Date: Nov. 6, 2014

(54) OFFLINE SEARCHING OF ENCRYPTED CONTENT

(71) Applicant: Thomson Reuters (Markets) LLC, Wilmington, DE (US)

(72) Inventor: Neeraj Kumar Parashar, New Delhi (IN)

(73) Assignee: THOMSON REUTERS (MARKETS) LLC, Wilmington, DE (US)

(21) Appl. No.: 14/255,402

(22) Filed: Apr. 17, 2014

Related U.S. Application Data
(60) Provisional application No. 61/819,698, filed on May 6, 2013.

(51) Int. Cl. G06F 17/30

(52) U.S. Cl. CPC G06F 17/30946; G06F 17/30964
USPC 707/741; 707/769

(57) ABSTRACT

The present disclosure is directed towards systems and methods for searching of encrypted content. Upon receiving a search request on an access device, the systems and methods of the present disclosure determine a requested content item type based on the search request and identify one or more responsive indices according to the requested content item type. The systems and methods of the present disclosure then interrogate the one or more responsive indices to determine one or more responsive index entries to the search request and generate one or more search results responsive to the search request comprising one or more responsive index entries and a document identifier for each responsive index entry. The systems and methods of the present disclosure then receive a selected search result, identify the encrypted content item associated with the selected search result according to the document identifier, decrypt and transmit the content item.

### CROSS-REFERENCE TO RELATED APPLICATION

This application claims priority to U.S. Provisional Application No. 61/819,698 filed May 6, 2013, entitled “Off-line Searching of Encrypted Content Stored in a Mobile Device,” the content of which is incorporated herein in its entirety.

### COPYRIGHT NOTICE

A portion of the disclosure of this patent document contains Material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

The disclosure relates generally to systems and methods for accessing content on mobile device. More specifically, the disclosure is directed to off-line searching of large amounts of encrypted content that are stored on a mobile device.

### BACKGROUND

Mobile technology continues to dramatically change the manner by which individuals access and consume data, as well as their expectations with regard to technological capabilities surrounding the mobile paradigm. As mobile technology capabilities expand, so do consumers' expectations, to the point where there exists an expectation of seamless connectivity and access to data in a platform-agnostic manner. The proliferation of smartphones, tablets, laptops, notebooks, subnotebooks and other mobile devices are simultaneously driving and answering this demand, while the supporting infrastructure strives to keep pace.

In some instances, however, such as with developing, countries (e.g., the BRICS countries), online connectivity is often unreliable or even unavailable some or most of the time (depending on time of day, location, etc.). Nevertheless, residents of these countries also desire and require access to accurate and current content for personal, professional or other reasons.

By way of example, a lawyer on her way to a trial or other court appearance may need ready and continuous access to legal content stored on a tablet or other mobile device. In several instances, such as with statutes, treatises, or general case law, the amount of content needed to be accessed may be voluminous and may be further compounded if more than one version of the particular content is required (e.g., the lawyer is required to access multiple versions of a statute). Preferably, the lawyer would acquire this content by wirelessly connecting her tablet or other mobile device to a server of a content provider (e.g. an Internet Content Provider (ICP)) and then downloading the required content for temporary or permanent storage on the device (e.g., in temporary cache in a SQL database such as SQLite or SQLServer). The content could be acquired through a subscription to the content provider's service or through other payment mechanism. However, on-line connectivity to the content provider's server would need to be maintained in order for the lawyer to continuously access the content that is desired.

Further, continuous on-line connectivity may not always be available due to a variety of factors, most notably geographical constraints. Therefore, it is desirable that the user be able to download content when she does have online connectivity to the content service provider in order to access (e.g. search) the content when online connectivity is unavailable.

In addition, when content is made available without on-line connectivity, it is also desirable that the content be encrypted or otherwise encoded to prevent subsequent content redistribution of the content. This is especially true where content is obtained through subscription or other payment mechanism. Yet, by encrypting content and subsequently storing the encrypted content on tablets or similar mobile devices, such as in a SQLite or SQLServer database, the content becomes inaccessible. Specifically, core functions, such as searching, cannot be undertaken because the content itself is encrypted. Therefore techniques are needed to allow a user to access (e.g., search) offline, large amounts of encrypted content that are stored in a mobile device such as a tablet.

### SUMMARY

The present disclosure is directed towards systems and methods for off-line searching of encrypted content. In one aspect, the method includes receiving a search request on an access device and determining a requested content item type based on the search request. One or more responsive indices are identified according to the requested content item type, the responsive one or more indices having been selected from a plurality of pre-populated indices maintained on the access device, each of the pre-populated indices associated with a content item type and including one or more index entries. Each index entry is associated with a corresponding content item.

The method further includes interrogating one or more responsive indices to determine one or more responsive index entries to the search request and generating one or more search results responsive to the search request. The one or more search results comprise the one or more responsive index entries to the search request and a document identifier for each of the one or more responsive index entries. A selected search result is received from the one or more search results responsive to the search request and a selected content item associated with the selected search result is identified according to the document identifier of the selected search result, the selected content item being in an encrypted format. The selected content item is decrypted and a signal associated with the decrypted content item is then generated and transmitted.

In one embodiment, the method further includes populating the plurality of pre-populated indices maintained on the access device prior to receiving the search request. The step of populating the plurality of pre-populated indices, according to one embodiment, further includes generating one or more folders, each folder maintaining one of the pre-populated indices and a set of corresponding content items for a given content item type. One of the pre-populated indices is then stored in a given one of the one or more folders having the same content item type as the content item type associated with the pre-populated index. The content item type of a content item is identified and one of the one or more folders having the same content item type as the content item type associated the content item is identified.

The method also includes populating the pre-populated index stored with an index entry corresponding to the content item. The pre-populated index is maintained in the folder having the same content item type as the content item type associated the content item. The index entry includes one or more data items regarding the content item, the one or more data items comprising at least a document identifier for the content item. The content item is then encrypted and stored in the folder having the same content item type as the content item type associated the content item.

According to one embodiment, the plurality of pre-populated indices is accessible on the access device in an off-line mode and the access device is a mobile device. A content item type may be one of a judicial caselaw item, a legislative content item or a miscellaneous legal content item and each of the plurality of pre-populated indices further includes one or more of a document identifier, temporal information, party information, participant information, content item keywords, content item text and content item reference information.

A system, as well as articles that include a machine-readable medium storing machine-readable program code for implementing the various techniques, are disclosed. Details of various embodiments are discussed in greater detail below.

Additional features and advantages will be readily apparent from the following detailed description, the accompanying drawings and the claims.

### BRIEF DESCRIPTION OF THE DRAWINGS

FIG. 1 is a schematic depicting an exemplary computer-based system for off-line searching encrypted content that are stored on an electronic device;

FIG. 2 is a flow diagram illustrating an exemplary computer-implemented method for generating encrypted content to be stored on an electronic device; and

FIG. 3 is a flow diagram illustrating an exemplary computer-implemented method for searching off-line encrypted content stored on an electronic device;

Like reference symbols in the various drawings indicate like elements.

### DETAILED DESCRIPTION

In the following description, reference is made to the accompanying drawings that form a part hereof, and in which is shown by way of illustration specific embodiments in which the disclosure may be practiced. It is to be understood that other embodiments may be utilized and structural changes may be made without departing from the scope of the present disclosure.

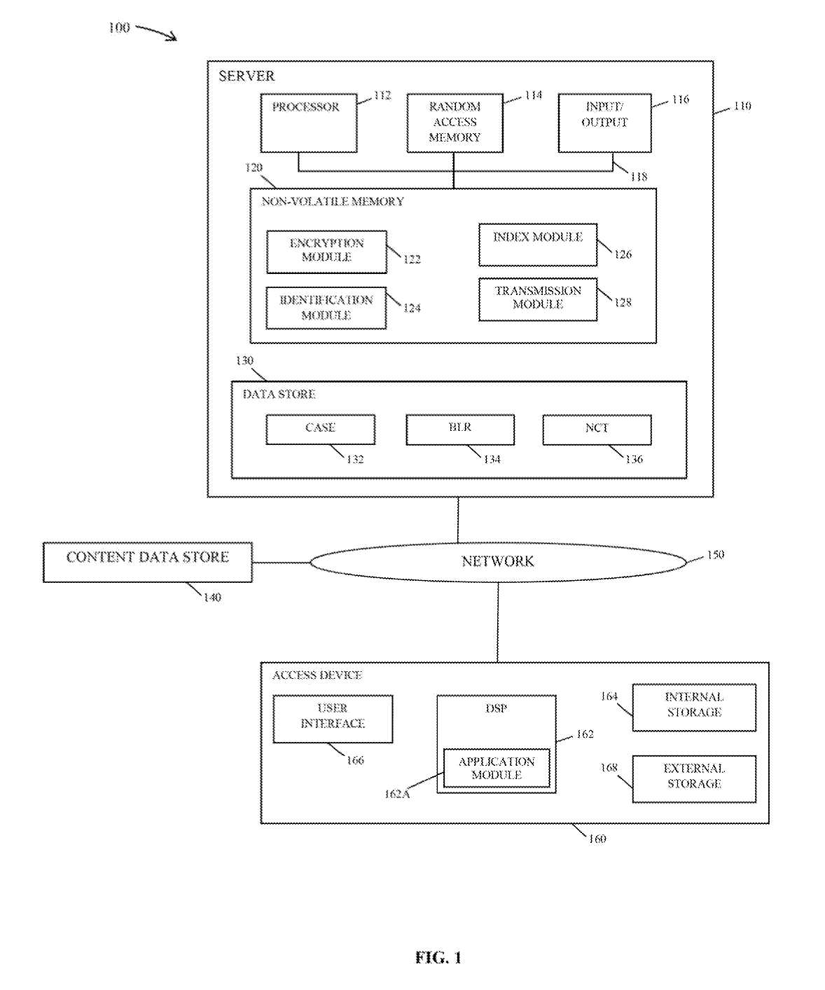

Turning now to FIG. 1, an example of a suitable computing system 100 within which embodiments of the present disclosure may be implemented is disclosed. The computing system 100 is only one example and is not intended to suggest any limitation as to the scope of use or functionality of the disclosure. Neither should the computing, system 100 be interpreted as having any dependency or requirement relating to any one or combination of illustrated components.

For example, the present disclosure is operational with numerous other general purpose or special purpose computing consumer electronics, network PCs, minicomputers, mainframe computers, laptop computers, as well as distributed computing environments that include any of the above systems or devices, and the like.

The disclosure may be described in the general context of computer-executable instructions, such as program modules, being executed by a computer. Generally, program modules include routines, programs, objects, components, data structures, loop code segments and constructs, etc. that perform particular tasks or implement particular abstract data types. The disclosure can be practiced in distributed computing environments where tasks are performed by remote processing devices that are linked through a communications network. In a distributed computing environment, program modules are located in both local and remote computer storage media including memory storage devices. Tasks performed by the programs and modules are described below and with the aid of figures. Those skilled in the art can implement the description and figures as processor executable instructions, which can be written on any form of a computer readable media.

In one embodiment, with reference to FIG. 1, the system 100 includes a server 110 configured to include a processor 112, such as a central processing unit (“CPU”), random access memory (“RAM”) 114, one or more input/output, devices 116, such as a display device (not shown) and keyboard (not shown) and non-volatile memory 120, all of which are interconnected via a common bus 118 and controlled by the processor 112.

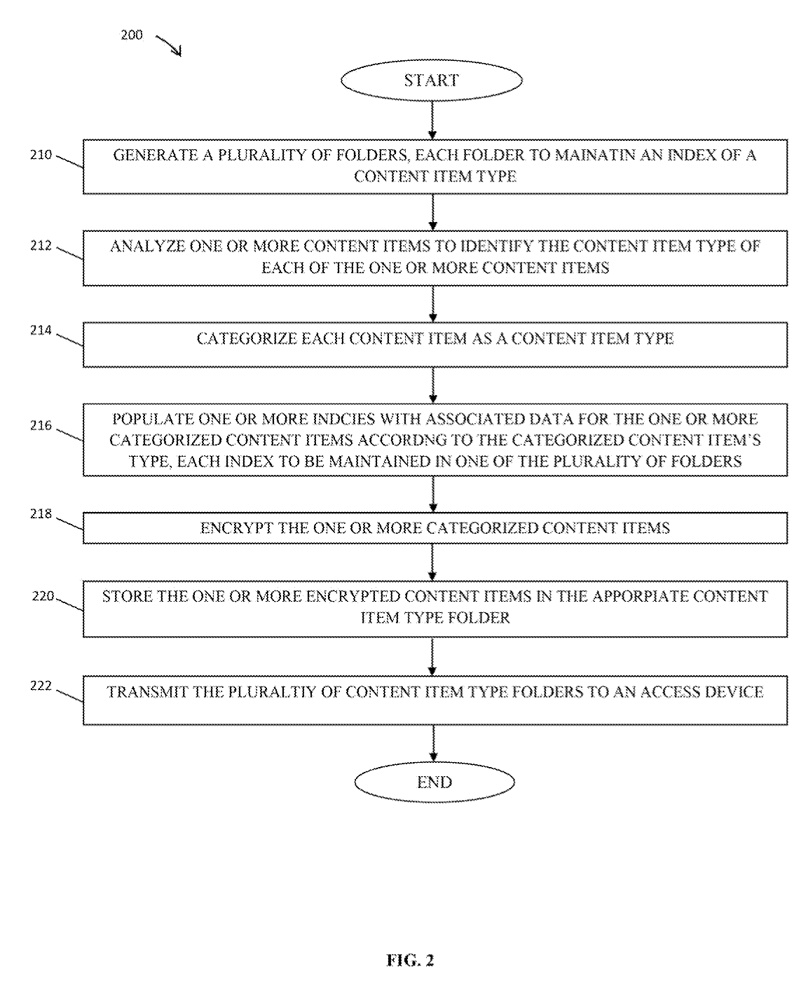

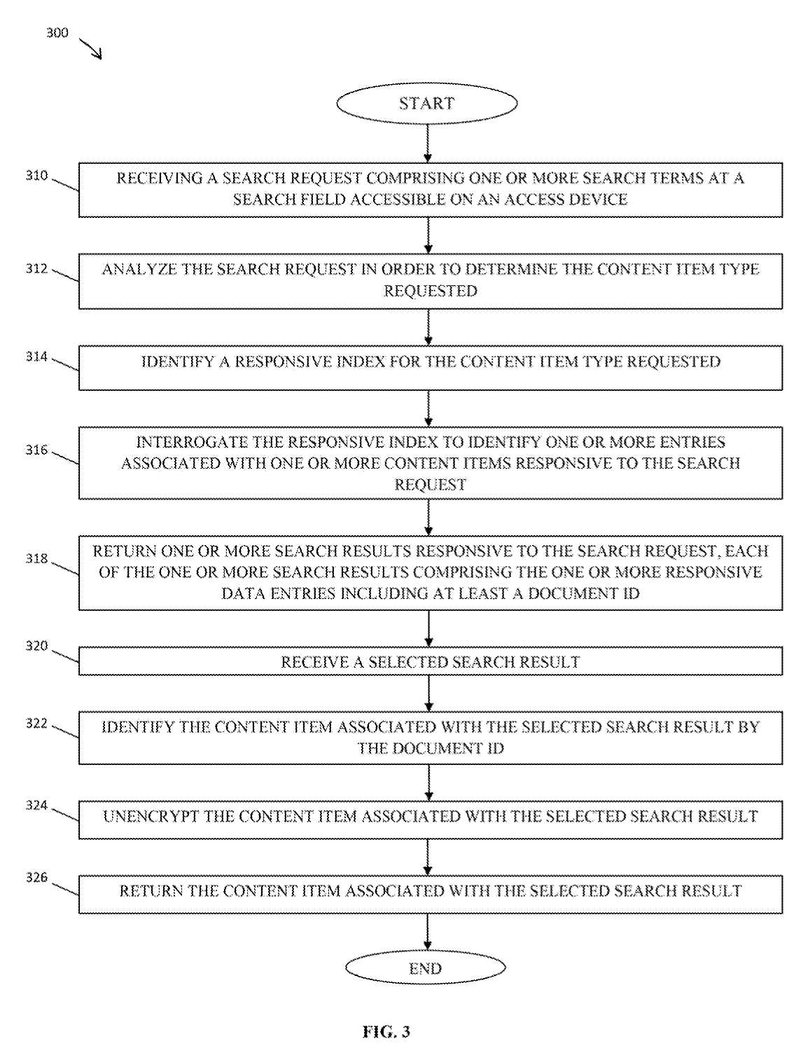

As shown in the FIG. 1 example, in one embodiment, the non-volatile memory 120 is configured to include an encryption module 122, an identification module 124, an index module 126 and a transmission module 128. The identification module 124 is configured to analyze one or more content items that are maintained in a content data store 140 in order to identify the content item type of each analyzed content item. The index module 126 is operative to populate one or more indices with associated data for the one or more categorized content items according to the categorized content item's type, each index to be maintained in the appropriate one of the plurality of folders within a data store 130. The encryption module 122 is configured to encrypt each content item that was categorized and referenced on the appropriate index maintained in the data store 110. The encryption module 122 employs encryption techniques as are known in the art, such as Advanced Encryption Standard (AES) 128 bit, 192 bit and 256 bit encryption specifications, and can employ portions or the entirety of the content item. The transmission module 128 is configured to transmit the plurality of content item type folders containing the one or more indices and the one or more encrypted and categorized content items to the access device 160. Additional details of these modules are 122, 124, 126 and 128 are discussed in connection with FIGS. 2 and 3.

As shown in FIG. 1, in one embodiment, a network 150 is provided that can include various devices such as routers, server, and switching elements connected in an Intranet, Extranet or Internet configuration. In one embodiment, the network 150 employs one or more wireless communication protocols to transfer information between an access device 160, the server device 110, a data store 130 and a content data store 140. For example, the network 150 may be a cellular or mobile network employing digital cellular standards including but not limited to the 3GPP, 3GPP2 and AMPS family of standards such as Global System for Mobile Communications (GSM), General Packet Radio Service (GPRS), CDMAOne, CDMA2000, Evolution-Data Optimized (EV-DO), LTE Advanced, Enhanced Data Rates for GSM Evolution (EDGE), Universal Mobile Telecommunications System (UMTS), Digital Enhanced Cordless Telecommunications (DECT), Digital AMPS (IS-136/TDMA), and Integrated Digital Enhanced Network (iDEN). The network 150 may also be a Wide Area Network (WAN), such as the Internet, which employs one or more transmission protocols, e.g. TCP/IP. As another example, the network 150 may employ a combination of digital cellular standards and transmission protocols. In another embodiment, the network 150 uses wired communications to transfer information between the access device 160, the server 110, the data store 130 and the content data store 140. In yet other embodiments, the network 150 employs a combination of wired and wireless technologies to transfer information between the access device 160, the server device 110, the data store 130 and the content data store 140.

The data store 130 is a repository that maintains and stores information utilized by the before-mentioned modules 122, 124, 126 and 128. In one embodiment, the data store 130 is a directory server, such as a Lightweight Directory Access Protocol (“LDAP”). In vet another embodiment, the data store 130 is an area of non-volatile memory 120 of the server 110.

In one embodiment, as shown in the FIG. 1 example, the data store 130 includes a database maintained in a Case folder 132, a database maintained in a BLR folder 134 and a database maintained in a NCT folder 136. According to one embodiment, the Case folder 132 includes encrypted judicial caselaw content items, as well as an index of the judicial caselaw content items. The BLR folder 134 maintains encrypted legislative content items, such as bills, laws, regulations, rules, statutes, acts and ordinances, as well as the associated index and the NCT folder 136 maintains encrypted miscellaneous legal content items, such as notifications, press notes, orders, legal notices, circulars and trade notices, along with its respective index.

In one embodiment, the content data store 140 is a repository that maintains and stores one or more content items utilized by the before-mentioned modules 122, 124, 126 and 128. In one embodiment, the content data store 140 is a relational database, such as Microsoft SQL Server. In another embodiment, the content data store 140 is a directory server, such as a Lightweight Directory Access Protocol (“LDAP”).

Although the data store 130 and the content data store 140 shown in FIG. 1 are connected to the network 150, it will be appreciated by one skilled in the art that the data store the data store 130 and the content data store 140 and/or any of the information shown therein, can be distributed across various servers and be accessible to the server 110 over the network 150, be coupled directly to the server 110, or be configured in an area of non-volatile memory 120 of the server 110.

The access device 160, according to one embodiment, is a mobile device having a user interface 166, a digital signal processor 162 with an application module 162A, an internal storage component 164, an external storage component 168, to power management system (not shown), an audio component (not shown), audio input/output components (not shown), an image capture and process system (not shown), RF antenna (not shown) and a subscriber identification module (SIM). The internal storage component 164 may include, for example, static random-access memory (SRAM) or Flash memory components. The external storage component 168 may include, for example, a peripheral storage device external to the access device 160, such as an external Secure Digital (SD) memory card. According to another embodiment, the access device 160, is a general purpose or special purpose computing device comprising a processor, transient and persistent storage devices, input/output subsystem, bus to provide a communications path between components comprising the general purpose or special purpose computer, and a web-based client application, such as a web browser, which allows a user to access the data stored within data store 130. Examples of web browsers are known in the art, such as Microsoft Internet Explorer, Google Chrome, Mozilla Fire fox and Apple Safari.

Further, it should be noted that the system 100 shown in FIG. 1 is only one embodiment of the disclosure. Other system embodiments of the disclosure may include additional structures that are not shown, such as secondary storage and additional computational devices. In addition, various other embodiments of the disclosure include fewer structures than those shown in FIG. 1. For example, in one embodiment, the disclosure is implemented on a single computing device in a non-networked standalone configuration. Data input and requests are communicated to the computing device via an input device, such as a keyboard and/or mouse. Data output, such as the computed significance score, of the system is communicated from the computing device to a display device, such as a computer monitor.

Turning now to FIG. 2, an exemplary method 200 for performing off-line searching of encrypted content stored on an electronic device is disclosed. In the illustrated embodiment shown in FIG. 2, the index module 126 generates a plurality of folders, each folder to maintain an index, of a content item type, step 210. In one embodiment, the index module 126 generates three folders for different content types, which is stored in the data store 130: the Case folder 132, the BLR folder 134 and the NCT folder 136. As described previously with respect to FIG. 1, in one embodiment, the Case folder 132 is configured to maintain judicial caselaw content items, as well as an index of the judicial caselaw content items, such as a judicial court opinion, decision or order; the BLR folder 134 is configured to maintain legislative content, such as bills, laws, regulations, rules, statutes, acts and ordinances as well as the associated index; and the NCT folder 136 is configured to maintain other miscellaneous legal content items, such as notifications, press notes, orders, legal notices, circulars and trade notices, along with its respective index. It is to be understood that the number of generated folders as well as the content items types maintained there are not limited to the folders content item types described herein and that other folders may be generated and maintain other types of content items.

The identification module 124 then analyzes one or more content items to identify the content item type of each of the one or more content items, step 212. According to one embodiment, the identification module 124 analyzes one or more content items that are maintained in the content data store 140 in order to identify the content item type of each analyzed content item. For example, in one embodiment, the identification module 124 analyzes each content item to determine if the item is a judicial caselaw item, a legislative content item or a miscellaneous legal content item. Once a determination is made as to the content item type, the identification module 124 categorizes each content item by its content item type, step 214. For example, in analyzing a recent ruling by the Supreme Court of the United States on the issue of proper jurisdiction for the enforcement of state laws, the identification module 124 categorizes the ruling as a judicial caselaw item.

Next, at step 216, the index module 126 populates one or more indices with index entries derived from associated data for the one or more categorized content items according to the categorized content item's type. Each index is stored in the appropriate one of the plurality of folders. In one embodiment, the index module 126 generates an index for each different content item type, namely a judicial caselaw item index, a legislative content item index and a miscellaneous legal content item index, which are stored in the appropriate respective folder within data store 130. For example, the judicial caselaw item index is stored in the Case folder 132.

As the identification module 124 categorizes each analyzed content item by content item type, the index module 126 populates the appropriate index with associated data for the analyzed content item. For example, if the identification module 124 identifies the content item as a judicial caselaw item, the judicial caselaw index in the Case folder 132 is populated by the index module 126 with the following exemplary data: a generated case ID value that identifies the content item, the date of the content item, such as the date the judicial opinion or order was rendered, the court name the case was issued from, the name of the judge or judges that issued the judicial case order or opinion, the identity of the parties, the identity of counsel representing, the parties, the subject of the case, any keywords, the text of the judicial order or judgment, editors notes regarding the judicial ease, other cases cited by the judicial opinion or order, legislative content items cited by the judicial opinion order, the appellate history of the case, comparative caselaw citations for the case, and whether a true copy of the judicial order or opinion is available in the corresponding content folder.

Similarly, if the content item is identified by the identification module 124 as a legislative content item, the legislative content item index in the BLR folder 134 is populated by the index module 126 with the following exemplary data a generated BLR ID value that identifies the content item, the authored date, issued date, commencement date, title, citation number, legislation number, legislation year, subject, table of contents, section heading, section commencement dates, section content, section amendment history or versions of the section, subject of the legislative content, state or states of the country where BLR is applicable, and status of the legislative content item. Alternatively, if the content item is identified by the identification module 124 as a miscellaneous legal content item, the miscellaneous legal content item index in the NCT folder 136 is populated by the index module 126 with the following exemplary data: a generated NCT ID value that identifies the content item; the title, text of the content, date and subject of the content item, state or states of the country where NCT is applicable and the ministry and/or department that issued the content item (e.g. the identity of the government department that issued a legal property notice).

Once the one or more indices are populated, the one or more categorized content items are then encrypted by the encryption module 122 and stored in the appropriate content item type folder, steps 218 and 220, respectively. According to one embodiment, the encryption module 122 encrypts each content item that was categorized and populated on the appropriate index stored in the Case folder 132, the BLR older 134 or the NCT folder 136 within the data store 130. The encryption module 122 employs encryption techniques as are known in the art, such as Advanced Encryption Standard (AES) 128 bit, 192 bit and 256 bit encryption specifications, and can employ portions or the entirety of the content item. In one embodiment, a substantial portion of the categorized content item is encrypted with the exception of certain identifying characteristics, such as the content item's name, date and document identification value. For example, a judicial caselaw content item may be encrypted by the encryption module 122 with the exception of the case ID value, case date, court name, and parties' names and a legislative content item may be encrypted with the exception of the BLR ID, legislation date and title.

As mentioned, once encrypted, the categorized content item may be then stored by the encryption module 122 in the appropriate folder along with the respective index, step 220. According to one embodiment a content item categorized as judicial caselaw is encrypted and stored in the Case folder 132, a content item categorized as a legislative content item is encrypted and stored in the BLR folder 134 and a content item categorized as a miscellaneous legal content item is stored in the NCT folder 136. It should be noted that at this juncture in the process, each content item type folder (Case folder 132, BLR folder 134 and NCT folder 136) contains both encrypted content item and un encrypted index referencing the encrypted content items

At step 222, the transmission module 128 then transmits the plurality of content item type folders to an access device. According to one embodiment, the transmission module 128 transfers the plurality of content item type folders containing, encrypted content items and the associated indices to a peripheral storage medium, such as an Secure Digital (SD) memory card, which can then be integrated on the access device 160 as the external storage component 168, and be accessible when the access device 160 is in an off-line mode. For example, a user of a mobile smartphone having an SD card slot can mount the SD card containing the content item type folders and access the indices and encrypted content stored on the SD card through an application on the smartphone. In another embodiment, the transmission module 128 generates and transmits a signal to the access device 160, including a link to the plurality of content item type folders, in which the access device 160 can download the plurality of content item type folders via the network 150 and store it on its internal storage 164 or on its external storage 168, in which the plurality of content item type folders are accessible when the access device 160 is in an off-line mode. In another embodiment, the transmission module 128 transmits the generated signal in response to a request for the plurality of content item type folders received through access device 160.

Turning now to FIG. 3, an exemplary method 300 for performing off-line searching of encrypted content stored on an access device is disclosed. In the illustrated embodiment shown in FIG. 3, the user interface 166 receives a search request comprising one or more search terms at one or more search fields accessible on the access device 160, step 310. According to one embodiment, the search fields may be made available on the electronic device through a locally stored software application stored on the internal storage 164. For example, the access device may be a mobile smartphone configured to operate a mobile operating system, such as the Android™ platform, and provides for the installation and operation of mobile software applications provided by third parties. Continuing with this example, a mobile software application installed on the mobile smartphone may be initiated by its digital signal processor, displayed on its graphical user interface with one or more search fields to receive a search request and can access the plurality of content item type folders maintained on the smartphone's external storage component. According to another embodiment, the search fields are made available on the electronic device through a web based software application, such a web browser.

Referring back to FIG. 3, according to one embodiment, the one or more search fields accessible on the access device 160 comprises a combination of vacant search fields configured to receive text inputs, such as the one or more terms of a search query string, and pre-defined search fields, which include a plurality of pre-defined search term input values. In one embodiment, a pre-defined search field is provided and includes pre-defined values for the content item type being sought. For example, in one embodiment, the graphical user interface on the smartphone displays a search field where a user can enter a search query string “state and law and jurisdiction” and select from a drop down menu the pre-defined input value of “judicial caselaw” as the type of content item being sought in another embodiment, the one or more search fields accessible on the access device 160 comprises one or more vacant search fields configured to receive text inputs in a form of a query string.

The search request, according to one embodiment, may be a combination of a query string comprising one or more search terms and one or more selections of pre-defined search term input values from pre-defined search fields. According to one embodiment, the query string may include one or more search terms provided as a Boolean expression, natural language string or combination thereof. The search request can be processed by any suitable process to identify a set of index searches that can be used in applying the query to the one or more search folders to return a set of results responsive to the query. For example, a user can enter a search request including a search query string “state and law and jurisdiction” and select from multiple drop down menus, pre-defined input values: “judicial caselaw” as the type of content item being sought and “Federal” as the issuing court jurisdiction being sought. The method 300, as shown in step 310, can use the search request to construct a formal query, i.e. a set of instructions, for example, Structured Query Language (“SQL”) instruction or instructions in any suitable query language or format that can be applied to the indices for the purpose of querying information that is relevant from the index.

Upon receipt of the search request, the application module 162A of the digital signal processor 162 analyzes the search request to determine the content item type requested, step 312. In one embodiment, the search request includes a selected pre-defined input value that specifies the content item type being sought. According, to another embodiment, the application module 162A identifies the content item type requested from the one or more search terms of the query string.

Next, at step 314, an index responsive to the content item type requested is identified by the application module 162A. According to one embodiment, the application module 162A, having determined that the content item type requested is for a judicial caselaw content item type, next identifies the judicial caselaw index in the Case folder 132 as the responsive index. Similarly, if the application module 162A determines that the content item type requested is legislative content, the application module 162A identifies the legislative content item index in the BLR folder 134 as the responsive index. Alternatively, if the application module 162A determines that the content item type requested is a miscellaneous legal content item, the application module 162A identifies the miscellaneous legal content item index in the NCT folder 136 as the responsive index.

Referring back to FIG. 3, the responsive index is then queried by the application module 162A to identify one or more entries associated with one or more of the content items responsive to the search request, step 316. According to one embodiment, the application module 162A, having identified the judicial caselaw index as the responsive index, interrogates the judicial caselaw index to identify a set of responsive entries associated with one or more of the content items. For example, if the search request included a search query string “(class action) and Pfizer and (Southern District of New York)” and a pre-defined input value of “judicial caselaw,” the application module 162A interrogates the judicial law index and identifies caselaw entries in the index which includes associated responsive data fields, such as “Party Name: Pfizer, Inc.,” “Subject: Class Action,” and “Court Name: S.D. N.Y.” According to one embodiment, the judicial case law index is maintained in Case folder 132, which is stored on external storage 168 of the access device 160, such as an external SD card. In another embodiment, the Case folder 132 with the judicial easel w index is stored in internal storage 164 on access device 160.

At step 318, one or more search results responsive to the search request are returned, each of the one or more search results comprising the one or more responsive data entries including at least a document ID. According to one embodiment, the application module 162A, having identified entries within the responsive index as responsive to the search request, returns each of the responsive entries in a set of search results that includes a document ID for each search result. The document ID is a value maintained in the index that identities the associated content item. Examples of document IDs include the case ID value in the judicial caselaw index, the BLR ID in the legislative content item index and the NCT ID in the miscellaneous legal content item index. According to one embodiment, the application module 162A returns the one or more search results for display on the user interface 166 of the access device 160. For example, the set of search results may include a listing, of four (4) cases, each case including a case ID (e.g. “Case 1”), the case caption (e.g. “Smith, et al. v. Pfizer, Inc.”), the case date (e.g. Nov. 21, 2011”) and the court name (e.g. “S.D.N.Y.”)

A selected search result is then received by the application module 162A at step 320. For example, the application module 162A receives notification that a search result has been selected on the access device 160. The content item associated with the selected search result is then identified by the document ID, step 322. According to one embodiment, the application module 162A, having received the selected search result, including the document ID for the selected search result, queries the appropriate content set associated with the responsive index, in order to identify the associated content item to the selected search result by the document ID. Continuing, from our previous example, the selected search result may be the first judicial case listing, which is identifiable by the document ID, “Case 1,” and the application module 162A interrogates the set of encrypted content items stored in the Case folder 132 to locate the content item having a document ID of “Case 1.”

Once the content item associated with the selected search result is located, the content item is unencrypted by the application module 162A, step 324. In one embodiment, the application module 162A utilizes the same decryption techniques utilized by the encryption module 122 to decrypt the content item. Encryption and decryption techniques are well known in the art, such as Advanced Encryption Standard (AES) 128 bit, 192 bit and 256 bit encryption/decryption specifications. Once the content item associated with the selected search result is decrypted, the decrypted content item is displayed in the user interface 166 of the access device 160, step 326.

FIGS. 1 through 3 are conceptual illustrations allowing, for an explanation of the present disclosure. It should be understood that various aspects of the embodiments of the present disclosure could be implemented in hardware, firmware, software, or combinations thereof. In such embodiments, the various components and/or steps would be implemented in hardware, firmware, and/or software to perform the functions of the present disclosure. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the disclosure as described herein. In this document, the terms “machine readable medium,” “computer program medium” and “computer usable medium” are used to generally refer to media such as a random access memory (RAM); a read only memory (ROM) a removable storage unit (e.g., a magnetic or optical disc, flash memory device, or the like); a hard disk; or the like.

Notably, the figures and examples above are not meant to limit the scope of the present disclosure to a single embodiment, as other embodiments are possible by way of interchange of some or all of the described or illustrated elements. Moreover, where certain elements of the present disclosure can be partially or fully implemented using known components, only those portions of such known components that are necessary for an understanding of the present disclosure are described, and detailed descriptions of other portions of such known components are omitted so as not to obscure the disclosure. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present disclosure encompasses present and future known equivalents to the known components referred to herein by way of illustration.

The foregoing description of the specific embodiments so fully reveals the general nature of the disclosure that others can, by applying knowledge within the skill of the relevant art(s) (including the contents of the documents cited and incorporated by reference herein), readily modify and/or adapt for various applications such specific embodiments, without undue experimentation,without departing from the general concept of the present disclosure. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present disclosure have been described above, it should be understood that they have been presented by way of example, and not limitations. It would be apparent to one skilled in the relevant art(s) that various changes in form and detail could be made therein without departing from the spirit and scope of the disclosure. Thus, the present disclosure should not be limited by any of the above-described exemplary embodiments, but should be defined only in accordance with the following claims and their equivalents.

What is claimed is:

1. A computer-implemented method for searching of encrypted content, the method comprising:
receiving a search request on an access device;
determining a requested content item type based on the search request;
identifying one or more responsive indices according to the requested content item type, the responsive one or more indices having been selected from a plurality of pre-populated indices maintained on the access device, each of the pre-populated indices associated with a content item type and comprising one or more index entries, each index entry associated with a corresponding content item;
querying the one or more responsive indices to determine one or more responsive index entries to the search request;
generating one or more search results responsive to the search request, the one or more search results comprising the one or more responsive index entries to the search request and a document identifier for each of the one or more responsive index entries;
receiving a selected search result from the one or more search results responsive to the search request;
identifying a selected content item associated with the selected search result according to the document identifier of the selected search result, the selected content item being in an encrypted format;
decrypting the selected content item;
generating a signal associated with the decrypted content item; and
transmitting the signal.

2. The computer-implemented method of claim 1 further comprising populating the plurality of pre-populated indices maintained on the access device prior to receiving the search request, wherein populating the plurality of pre-populated indices further comprises:
generating one or more folders, each folder to maintain one of the pre-populated indices and a set of corresponding content items for a given content item type;
storing one of the pre-populated indices in a given one of the one or more folders having the same content item type as the content item type associated with the pre-populated index;
identifying the content item type of a content item;
identifying one of the one or more folders having the same content item type as the content item type associated the content item;
populating the pre-populated index stored with an index entry corresponding to the content item, the pre-populated maintained in the folder having the same content item type as the content item type associated the content item, the index entry comprising one or more data items regarding the content item, the one or more data items comprising at least a document identifier for the content item;
encrypting the content item; and
storing the encrypted content item in the folder having the same content item type as the content item type associated the content item.

3. The computer-implemented method of claim 1, wherein the plurality of pre-populated indices are accessible on the access device in an off-line mode.

4. The computer-implemented method of claim 1, wherein the access device is a mobile device.

5. The computer-implemented method of claim 1, wherein a content item type is one of a judicial caselaw item, a legislative content item or a miscellaneous legal content item

6. The computer-implemented method of claim 1, wherein each of the plurality of pre-populated indices further comprises one or more of a document identifier, temporal information, party information, participant information, content item keywords, content item text and content item reference information.

7. An access device for searching of encrypted content, the access device comprising:
a processor; and
a memory coupled to the processor, the memory storing instructions that cause the processor to:
receive a search request on an access device;
determine a requested content item type based on the search request;
identify one or more responsive indices according to the requested content item type, the responsive one or more indices having been selected from a plurality of pre-populated indices maintained on the access device, each of the pre-populated indices associated with a content item type and comprising one or more index entries, each index entry associated with a corresponding content item;
query the one or more responsive indices to determine one or more responsive index entries to the search request;
generate one or more search results responsive to the search request, the one or more search results comprising the one or more responsive index entries to the search request and a document identifier for each of the one or more responsive index entries;
receive a selected search result from the one or more search results responsive to the search request;
identify a selected content item associated with the selected search result according to the document identifier of the selected search result, the selected content item being in an encrypted format;
decrypt the selected content item;
generate a signal associated with the decrypted content item; and
transmit the signal.

8. The access device of claim 7, wherein the access device in an off-line mode.

9. The access device of claim 7, wherein the access device is a mobile device.

10. The access device of claim 7, wherein a content item type is one of a judicial caselaw item, a legislative content item or a miscellaneous legal content item.

11. The access device of claim 7, wherein each of the plurality of pre-populated indices further comprises one or more of a document identifier, temporal information, party information, participant information, content item keywords, content item text and content item reference information.

12. A system comprising:
a server including a processor and memory storing instructions that cause the processor to populate a plurality of pre-populated indices, wherein the memory of the server stores instructions that further cause the processer to:
generate one or more folders, each folder to maintain one of the pre-populated indices and a set of corresponding content items for a given content item type;
store one of the pre-populated indices in a given one of the one or more folders having the same content item type as the content item type associated with the pre-populated index;
identify the content item type of a content item;
identify one of the one or more folders having the same content item type as the content item type associated the content item;
populate the pre-populated index stored with an index entry corresponding to the content item, the pre-populated maintained in the folder having the same content item type as the content item type associated the content item, the index entry comprising one or more data items regarding the content item; the one or more data items comprising at least a document identifier for the content item;
encrypt the content item; and
store the encrypted content item in the folder having the same content item type as the content item type associated the content item.

13. The system of claim 12 wherein the one or more folders are stored on an access device.

14. A system for searching of encrypted content, the system comprising:
a server including a processor and memory storing instructions that cause the processor to:
generate one or more folders, each folder to maintain one of a plurality of pre-populated indices and a set of corresponding content items for a given content item type;
store a given one of the plurality of pre-populated indices in a given one of the one or more folders having the same content item type as the content item type associated with the pre-populated index;
identify the content item type of a content item;
identify one of the one or more folders having the same content item type as the content item type associated the content item;
populate the pre-populated index stored with an index entry corresponding to the content item, the pre-populated maintained in the folder having the same content item type as the content item type associated the content item, the index entry comprising One or more data items regarding the content item, the one or more data items comprising at least a document identifier for the content item;
encrypt the content item; and
store the encrypted content item in the folder having the same content item type as the content item type associated the content item; and
an access device comprising a processor and a memory coupled to the processor, the memory storing instructions that cause the processor to:
store the one or more folders on a storage medium of the access device;
receive a search request;
determine a requested content item type based on the search request;
identify one or more responsive indices according to the requested content item type, the responsive one or more indices having been selected from the plurality of pre-populated indices maintained on the access device within the one or more folders, each of the pre-populated indices associated with a content item type and comprising one or more index entries, each index entry associated with a corresponding content item;
query the one or more responsive indices to determine one or more responsive index entries to the search request;
generate one or more search results responsive to the search request, the one or more search results comprising the one or more responsive index entries to the search request and a document identifier for each of the one or more responsive index entries;
receive a selected search result from the one or more search results responsive to the search request;
identify a selected content item associated with the selected search result according to the document identifier of the selected search result, the selected content item being in an encrypted for at;
decrypt the selected content item;
generate a signal associated with the decrypted content item; and
transmit the signal.

15. The system of claim 14, wherein the access device in an off-line mode.

16. The system of claim 14, wherein the access device is a mobile device.

17. The system of claim 14, wherein a content item type is one of a judicial caselaw item, a legislative content item or a miscellaneous legal content item.

18. The system of claim 14, wherein each of the plurality of pre-populated indices further comprises one or more of a document identifier, temporal information, party information, participant information, content item keywords, content item text and content item reference information.
